(19) United States
(12) Patent Application Publication
(10) Pub. No.: US 2017/0265146 A1
(43) Pub. Date: Sep. 14, 2017

(54) CONTROL METHOD FOR RF RECEIVER AND USER EQUIPMENT

(71) Applicant: MEDIATEK INC., Hsin-Chu (TW)

(72) Inventors: Tzyuan SHIU, Taipei City (TW); Tzung-Han WU, Hsinchu City (TW); Shih-Chieh YEN, Taipei City (TW); Wei-Nan SUN, Zhubei City (TW); Wei Yu LAI, Hsinchu City (TW); Caiyi WANG, Austin, TX (US)

(21) Appl. No.: 15/453,956

(22) Filed: Mar. 9, 2017

Related U.S. Application Data
(60) Provisional application No. 62/305,549, filed on Mar. 9, 2016.

(51) Int. Cl. H04W 52/24; H04B 17/318; H04B 17/345; H04B 17/336

(52) U.S. Cl. CPC H04W 52/241; H04B 17/336; H04B 17/318; H04B 17/345

(57) ABSTRACT

A control method for a radio frequency (RF) receiver of a user equipment (UE) and UE are provided. The control method includes the steps of detecting whether at least one blocker exists; determining a current scenario of the UE when the blocker does not exist; obtaining a signal-to-noise-ratio (SNR) target corresponding to the current scenario; and selecting an operation mode from a plurality of power modes according to the SNR target to operate the RF receiver.

### CROSS REFERENCE TO RELATED APPLICATIONS

This Application claims priority of U.S. Provisional Patent Application No. 62/305,549, filed on Mar. 09, 2016, the entirety of which is incorporated by reference herein.

### BACKGROUND OF THE INVENTION

Field of the Invention

The invention generally relates to a controlling technology for a radio frequency (RF) receiver, and more particularly, to a control method for determining a power mode of the RF receiver according to different scenarios.

Description of the Related Art

Wireless communication systems are widely used to provide various telecommunication services such as telephony, video, data, messaging, and broadcast services. Typical wireless communication systems may employ multiple-access technologies capable of supporting communication with multiple users by sharing available system resources (e.g., bandwidth, transmission power).

Multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by the Third Generation Partnership Project (3GPP). It is designed to better support mobile broadband Internet access by improving spectral efficiency, lowering costs, improving services, making use of new spectrums, and integrating better with other open standards using OFDMA on downlinks (DL), and SC-FDMA on uplinks (UL) and multiple-input multiple-output (MIMO) antenna technology.

In the user equipment (UE) (e.g. mobile phone), multiple frequency bands and standards are implemented by using a radio frequency (RF) receiver that may be coupled to one or more antennas. When the UE controls the RF receiver, the UE may consider all possible factors to search for an optimal configuration for the RF receiver. However, strong distortions can be introduced by the transient behaviors of unnecessary RF configuration changes.

### BRIEF SUMMARY OF THE INVENTION

A control method for a radio frequency (RF) receiver and user equipment (UE) are provided to overcome the problems mentioned above.

An embodiment of the invention provides a control method for an RF receiver of a UE. The control method comprises the steps of detecting whether at least one blocker exists; determining a current scenario of the UE when the blocker does not exist; obtaining a signal-to-noise-ratio (SNR) target corresponding to the current scenario; and selecting an operation mode from a plurality of power modes according to the SNR target to operate the RF receiver.

In some embodiments of the invention, the control method further comprises the step of operating the RF receiver in a high-power mode when the blocker exists.

In some embodiments of the invention, the control method further comprises the steps of determining whether the current scenario is known, obtaining the SNR target according a pre-defined SNR corresponding to the current scenario, when information of the current scenario is known, and obtaining the SNR target by estimating an inner SNR corresponding to the current scenario, when the information of the current scenario is unknown.

In some embodiments of the invention, the control method further comprises the steps of estimating an SNR corresponding to the RF receiver in a low-power mode, determining whether the SNR is larger than the SNR target, and operating the RF receiver in the low-power mode when the SNR is larger than the SNR target.

In some embodiments of the invention, the current scenario is one of service applications of the UE. In some embodiments of the invention, the current scenario is existence of down link (DL) received-signal-strength-indication (RSSI) or existence of co-channel interference (CCI).

An embodiment of the invention provides a UE. The user equipment comprises an RF receiver and a processor. The processor detects whether at least one blocker exists, and when the blocker does not exist. When the blocker does not exist, the processor determines a current scenario of the UE. The processor further obtains a signal-to-noise-ratio (SNR) target corresponding to the current scenario and selects an operation mode from a plurality of power modes according to the SNR target to operate the RF receiver.

Other aspects and features of the invention will become apparent to those with ordinary skill in the art upon review of the following descriptions of specific embodiments of methods and devices.

### BRIEF DESCRIPTION OF THE DRAWINGS

The invention will become more fully understood by referring to the following detailed description with reference to the accompanying drawings, wherein:

FIG. 1 is a block diagram of a mobile communications system 100 according to an embodiment of the invention;

FIG. 2 is a block diagram of an RF receiver 112 according to an embodiment of the invention;

FIG. 3 is a schematic diagram illustrating the blockers according to an embodiment of the invention.

FIG. 4 is a flow chart illustrating the control method for an RF receiver of an UE according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

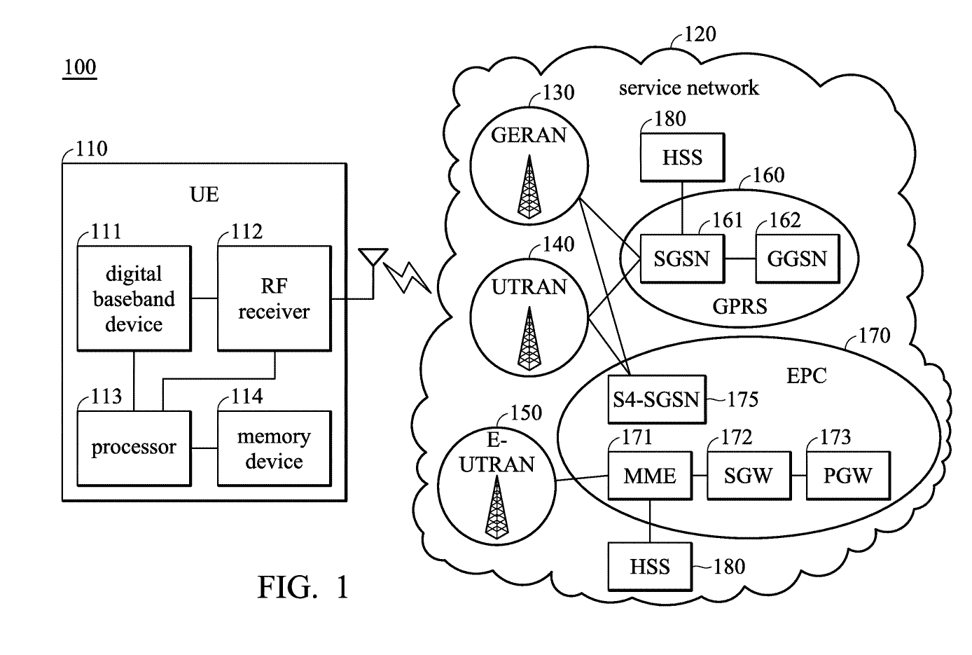

FIG. 1 is a block diagram of a mobile communications system 100 according to an embodiment of the invention. The system 100 comprises User Equipment (UE) 110 and a service network 120. The UE 110 may be a mobile communications device, such as a cellular phone, a smartphone modem processor, a data card, a laptop stick, a mobile hotspot, a USB modem, a tablet, etc.

The UE 110 may comprise at least a digital baseband (DBB) device 111, a radio frequency (RF) receiver 112, a processor 113, a memory device 114, and an antenna module comprising at least one antenna. Note that, in order to clarify the concept of the invention, FIG. 1 presents a simplified block diagram in which only the elements relevant to the invention are shown. However, the invention should not be limited to what is shown in FIG. 1.

The digital baseband device 111 may process the baseband signals to obtain information or data transmitted by the peer communications apparatus. The digital baseband device 111 may also comprise a plurality of hardware elements to perform baseband digital-signal processing. The baseband digital-signal processing may comprise digital-to-analog conversion, gain adjustment, modulation/demodulation, encoding/decoding, and so on.

The RF receiver 112 may receive RF signals via the antenna and process the received RF signals to convert the received RF signals to baseband signals to be processed by the digital baseband device 111, or receive baseband signals from the digital baseband device 111 and convert the received baseband signals to RF signals to be transmitted to a peer communications apparatus.

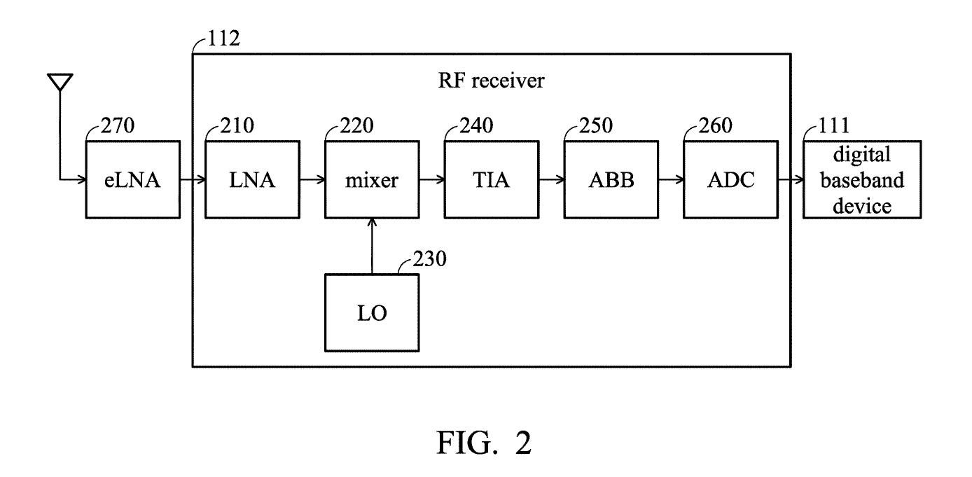

The RF receiver 112 may comprise a plurality of hardware elements to perform radio frequency conversion. FIG. 2 is a block diagram of an RF receiver 112 according to an embodiment of the invention. As shown in FIG. 2, the RF receiver 112 may comprise low-noise amplifier (LNA) 210, mixer 220, a local oscillator (LO) 230 a trans-impedance amplifier (TIA) 240, an analog base band (ABB) device 250, and an analog-to-digital convertor (ADC) 260. The LNA 210 may be further coupled to an external LNA (eLNA). Note that, in order to clarify the concept of the invention, FIG. 2 presents a simplified block diagram in which only the elements relevant to the invention are shown. However, the invention should not be limited to what is shown in FIG. 2.

The LNA gain of the LNA 210 can be adjusted according to the operation mode (or operation state) of the RF receiver 112. When the LNA 210 has larger LNA gain, lager current consumption and better RF signal-to-noise ratio (SNR) may occur. The LO 230 may be operated in different operation modes (or operation states) according to the operation mode of the RF receiver 112 to trade off the LO phase noise performance with the current consumption. The TIA 240 may be operated in different operation modes (or operation states) according to the operation mode of the RF receiver 112 to trade off the linearity performance with the current consumption. The ABB 250 may be operated in an activated state or bypassed state according to the operation mode of the RF receiver 112 to trade off the filter rejection with the current consumption.

The processor 113 may control the operations of the digital baseband device 111 and the RF receiver 112. According to an embodiment of the invention, the processor 113 may also be arranged to execute the program codes of the software module(s) of the corresponding digital baseband device 111 and/or the RF receiver 112. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of the corresponding software module(s).

In addition, in some embodiments of the invention, the processor 113 may be configured inside of the digital baseband device 111 or the RF receiver 112. In addition, in some embodiments of the invention, the UE 110 may comprise another processor configured inside of the digital baseband device 111 or the RF receiver 112. Thus the invention should not be limited to the architecture shown in FIG. 1.

The memory device 114 may store the software and firmware program codes, system data, user data, etc. of the UE 110. The memory device 114 may be a volatile memory such as a Random Access Memory (RAM); a non-volatile memory such as a flash memory or Read-Only Memory (ROM); a hard disk; or any combination thereof.

The service network 120 may comprise a GSM EDGE Radio Access Network (GERAN) 130, a Universal Terrestrial Radio Access Network (UTRAN) 140, an Evolved UTRAN (E-UTRAN) 150, a General Packet Radio Service (GPRS) subsystem 160 and an Evolved Packet Core (EPC) subsystem 170. The GERAN 130, UTRAN 140 and E-UTRAN 150 may be in communication with the GPRS subsystem 160 or the EPC subsystem 170, wherein the GERAN 130, UTRAN 140 and E-UTRAN 150 allow connectivity between the UE 110 and the GPRS subsystem 160 or the EPC subsystem 170 by providing the functionality of wireless transmission and reception to and from the UE 110 for the GPRS subsystem 160 or the EPC subsystem 170, and the GPRS subsystem 160 or the EPC subsystem 170 signals the required operation to the GERAN 130, UTRAN 140 and E-UTRAN 150 for providing wireless services to the UE 110. The GERAN 130, UTRAN 140 and E-UTRAN 150 may contain one or more base stations (or called NodeBs or eNodeBs) and Radio Network Controllers (RNCs). Specifically, the GPRS subsystem 160 includes a Serving GPRS (General Packet Radio Services) Support Node (SGSN) 161 and a Gateway GPRS Support Node (GGSN) 162, wherein the SGSN 161 is the key control node for packet routing and transfer, mobility management (e.g., attach/detach and location management), session management, logical link management, and authentication and charging functions, etc., and the GGSN 162 is responsible for Packet Data Protocol (PDP) address assignments and interoperability with external networks. The EPC subsystem 170 may comprise a Mobility Management Entity (MME) 171, which may be responsible for idle mode UE tracking, paging procedures, and attachment and activation processes. The EPC subsystem 170 may also comprise a Servicing Gateway (SGW) 172, which may be responsible for the routing and forwarding of data packets. The EPC subsystem 170 may also include a Packet data network Gateway (PGW) 173, which may be responsible for providing connectivity from the UE 110 to external networks. Both the SGSN 161 and the MME 171 may be in communication with Home Subscriber Server (HSS) 180 which may provide device identification information, an International Mobile Subscriber Identity (IMSI), etc. It should be appreciated that the EPC subsystem 170 may also comprise a S4-SGSN 175, thereby allowing the GERAN 130 or UTRAN 140 to be accessed when the GPRS subsystem 160 is replaced by the EPC subsystem 170. Additionally, the service network 120 may also include other functional entities, such as a Home Location Register (HLR) (not shown) which is a central database storing user-related and subscription-related information, and the invention is not limited thereto. In an embodiment of the invention, the service network 120 may also comprise a Code Division Multiple Access (CDMA) network.

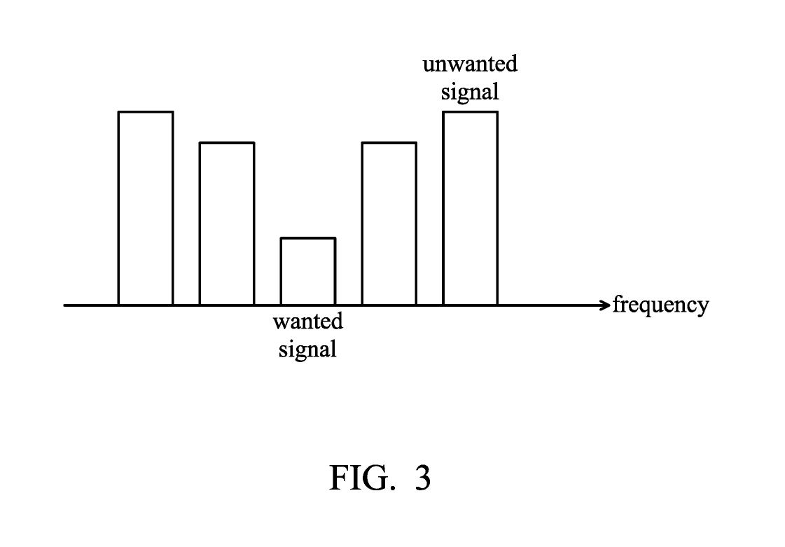

In an embodiment of the invention, when the processor 113 determines the operation mode of the RF receiver 112, the processor 113 may detect whether at least one blocker exists first. The blocker may be any unwanted interference which is located outside from the wanted signal of the UE 110. FIG. 3 is a schematic diagram illustrating the blockers according to an embodiment of the invention. As shown in FIG. 3, the signals located outside from the wanted signal are regarded as the blockers. In the embodiment, when a blocker exists, the processor 113 may directly set the operation mode of the RF receiver is a high-power mode. When a blocker does not exist, the processor 113 may determine a current scenario of the UE 110. In an embodiment of the invention, the processor 113 may further determine whether the blocker is a strong blocker. Namely, the processor 113 may determine whether the power level of the blocker is higher than a predetermined value. When the power level of the blocker is higher than the predetermined value, the processor 113 may determine that the blocker is a strong blocker or may determine that the blocker exists. The strong blocker is a blocker that has a higher power level and may influence the wanted signal. Namely, if the power level of the blocker is very weak (i.e. not a strong blocker), the processor 113 may neglect the blocker, i.e. the processor 113 may determine that the blocker does not exist.

In an embodiment of the invention, the RF receiver 112 can be operated in different power modes, such as a high-power mode or a low-power mode. When the RF receiver 112 is operated in the low-power mode, the power consumption can be reduced. When the RF receiver 112 is operated in the high-power mode, better system performance can be achieved. In an embodiment of the invention, the related operations and settings of the RF receiver 112 in different power modes are predefined in the UE 110. The processor 113 may select or switch the appropriate operation mode for the RF receiver 112 according to the current scenario. Note that, in order to clarify the embodiments of the invention, only a high-power mode and a low-power mode are illustrated in the invention, but the invention should not be limited thereto. The power modes of the RF receiver 112 may comprise more than two power modes.

In an embodiment of the invention, the scenario of the UE 110 may comprise static scenarios and dynamic scenarios.

The static scenarios may be related to the service applications of the UE 110. The service applications may be voice applications or data reception. The voice applications may comprise 2G/3G voice service and Voice over Long-Term Evolution (VoLTE) service, but the invention should not be limited thereto. The data reception may comprise IDLE mode reception and Physical downlink Control Channel only (PDCCH-only) reception, but the invention should not be limited thereto. In the IDLE mode reception, the UE 110 only needs to monitor system information which is broadcasted to all UEs. In the PDCCH-only reception, the UE 110 keeps monitoring all down link (DL) data packets to check if there is any dedicated data transmission for the UE 110.

The dynamic scenarios may be related to environmental conditions. The environmental conditions may comprise existence of down link (DL) received-signal-strength-indication (RSSI), TX powers, existence of co-channel interference (CCI) and UE mobility, but the invention should not be limited thereto.

In an embodiment of the invention, the UE 110 may determine whether the DL RSSI is larger than a predetermined value. When the DL RSSI is larger than the predetermined value, the UE 110 may determine that the DL RSSI is a large DL RSSI, i.e. the UE 110 may determine that the DL RSSI exists. When the DL RSSI is not larger than the predetermined value, the UE 110 may determine that the DL RSSI is very weak or the DL RSSI does not exist. When the DL RSSI is large, the RF SNR will be large as well. Therefore, in the embodiment of the invention, when the DL RSSI is a large DL RSSI, the RF receiver 112 may be operated in the low-power mode. When the DL RSSI is not a large DL RSSI, the RF receiver 112 may be operated in the high-power mode.

In an embodiment of the invention, information related to some scenarios may be defined in advance, i.e. the scenarios are predefined in the UE 110. For example, a specific scenario may correspond to a specific signal-to-noise ratio (SNR) or a specific SNR range. Therefore, when the information related to one scenario is known (i.e. the scenario has been predefined in the UE 110), the processor 113 may directly obtain the SNR corresponding to the scenario based on the predefined information related to the scenario.

In an embodiment of the invention, the processor 113 may determine the current scenario of the UE 110 according to the control information from the digital baseband device 111 and the RF receiver 112. For example, the processor 113 may obtain the blocker information from the output of the LNA 210 or TIA 240 of the RF receiver 112, and the processor 113 may obtain the SNR estimation, mobility indicator, TX power level, RX power level, and Modulation-coding scheme (MCS) from the digital baseband device 111.

When the processor 113 determines the current scenario of the UE 110, the processor 113 may determine whether information of the current scenario is known, i.e. the processor 113 may determine whether the scenario has been predefined in the UE 110. If information of the current scenario is known, the processor 113 may obtain an SNR target according a pre-defined SNR corresponding to the current scenario. For example, when the information of the current scenario is known, the processor 113 may look up an appropriate SNR (i.e. pre-defined SNR) from the pre-defined information (e.g. from a lookup table) corresponding to the current scenario, and select the appropriate SNR as the SNR target. In an embodiment of the invention, the processor 113 determines whether information of the current scenario is known by determining whether the SNR requirement of system service (e.g. voice service) is known.

If the information of the current scenario is unknown, the processor 113 may estimate an inner SNR corresponding to the current scenario according to the inner requirement. The processor 113 may obtain the inner requirement by estimating (or detecting) the inner SNR in the current environment. In an embodiment of the invention, the processor 113 may estimate the inner SNR according to the co-channel interference (CCI), if the CCI dominates the undesired in-band signals. After the processor 113 estimates the inner SNR, the processor 113 may add a threshold TH (e.g. an upper bound value) to the inner SNR. Then, the SNR target may be regarded as the inner SNR plus the threshold TH. In an embodiment of the invention, the threshold TH may be predefined or adjustable according to different applications.

After the processor 113 derive the SNR target, the processor 113 may estimate an SNR_{LPM} corresponding to the RF receiver in a low-power mode. Namely, the processor 113 may estimate the SNR which the RF receiver 112 can provide for when the RF receiver 112 is in the low-power mode. Then, the processor 113 may compare the SNR target with the SNR_{LPM} to determine whether the SNR_{LPM} is larger than the SNR target. When the SNR_{LPM} is larger than the SNR target, it means that the RF receiver 112 may provide enough SNR in the low power mode. Thus, the RF receiver 112 will be operated in the low-power mode to save power. When the SNR_{LPM} is not larger than the SNR target, it means that if the RF receiver 112 is operated in the low power mode, the RF receiver 112 may not provide enough SNR for the current operation. Thus, the RF receiver 112 will be operated in the high-power mode to achieve better system performance.

In an embodiment of the invention, when the RF receiver 112 is operated in the low-power mode, the LNA gain of the LNA 210 will be reduced. When the RF receiver 112 is operated in the low-power mode, the LO 230 and TIA 240 may need a lower supply current. When the RF receiver 112 is operated in the low-power mode, the ABB 250 may be operated in a bypassed state. Furthermore, when the RF receiver 112 is operated in the low-power mode, the dynamic range of the ADC 260 will be reduced. In an embodiment of the invention, when the RF receiver 112 is operated in the low-power mode, the external LNA will be bypassed.

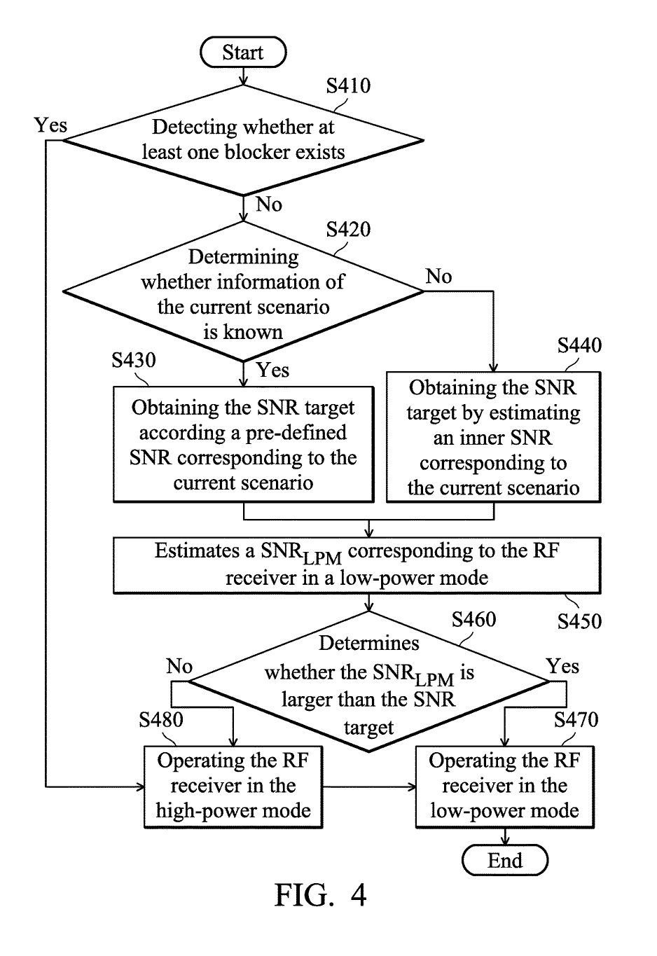

FIG. 4 is a flow chart 400 illustrating the control method for an RF receiver of an UE according to an embodiment of the invention. The control method is applied to the UE 110. First, in step S410, the UE 110 detects whether at least one blocker exists. If the blocker does not exist, step S420 is performed. In step S420, the UE 110 determines whether information of the current scenario is known. If the information of the current scenario is known, step S430 is performed. In step S430, the UE 110 obtains the SNR target according a pre-defined SNR corresponding to the current scenario. If the information of the current scenario is unknown, step S440 is performed. In step S440, the UE 110 obtains the SNR target by estimating an inner SNR corresponding to the current scenario.

In step S450, the UE 110 estimates an SNR_{LPM} corresponding to the RF receiver 112 in a low-power mode. In step S460, the UE 110 determines whether the SNR_{LPM} is larger than the SNR target. If the SNR_{LPM} is larger than the SNR target, step S470 is performed. In step S470, the UE 110 operates the RF receiver 112 in the low-power mode. If the SNR_{LPM} is not larger than the SNR target, step S480 is performed. In step S480, the UE 110 operates the RF receiver 112 in the high-power mode. If the blocker exists, step S480 is performed.

In the control method of the invention, the UE 110 can control or switch the operation mode of the RF receiver 113 flexibly. The UE 110 can focus on the current scenario to switch or select the appropriate operation mode of the RF receiver 113 without concerning all factors at the same time to trade off the system performance and the power consumption.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A control method for a radio frequency (RF) receiver of a user equipment (UE), comprising:
detecting whether at least one blocker exists;
determining a current scenario of the UE when the blocker does not exist;
obtaining a signal-to-noise-ratio (SNR) target corresponding to the current scenario; and
selecting an operation mode from a plurality of power modes according to the SNR target to operate the RF receiver.

2. The control method of claim 1, further comprising:
operating the RF receiver in an high-power mode when the blocker exists.

3. The control method of claim 1, further comprising:
determining whether information of the current scenario is known; and
obtaining the SNR target according a pre-defined SNR corresponding to the current scenario, when the information of the current scenario is known.

4. The control method of claim 3, further comprising:
obtaining the SNR target by estimating an inner SNR corresponding to the current scenario, when the information of the current scenario is unknown.

5. The control method of claim 1, further comprising:
estimating an SNR corresponding to the RF receiver in a low-power mode.

6. The control method of claim 5, further comprising:
determining whether the SNR is larger than the SNR target; and
operating the RF receiver in the low-power mode when the SNR is larger than the SNR target.

7. The control method of claim 1, wherein the current scenario is one of the service applications of the UE.

8. The control method of claim 7, wherein the current scenario is a voice application or a data reception.

9. The control method of claim 1, wherein the current scenario is one of the environmental conditions.

10. The control method of claim 9, wherein the current scenario is existence of down link (DL) received-signal-strength-indication (RSSI) or existence of co-channel interference (CCI).

11. A user equipment (UE), comprising:
a radio frequency receiver; and
a processor, coupled to the radio frequency receiver,
wherein the processor detects whether at least one blocker exists, and when the blocker does not exist, the processor determines a current scenario of the UE, and the processor obtains a signal-to-noise-ratio (SNR) target corresponding to the current scenario and selects an operation mode from a plurality of power modes according to the SNR target to operate the RF receiver.

12. The user equipment of claim 11, wherein the RF receiver is operated in an high-power mode when the blocker exists.

13. The user equipment of claim 11, wherein the processor further determines whether the current scenario is known, and when information of the current scenario is known the processor obtains the SNR target according a pre-defined SNR corresponding to the current scenario.

14. The user equipment of claim 13, wherein the processor obtains the SNR target by estimating an inner SNR corresponding to the current scenario, when the information of the current scenario is unknown.

15. The user equipment of claim 11, wherein the processor further estimates an SNR corresponding to the RF receiver in a low-power mode.

16. The user equipment of claim 15, wherein the processor further determines whether the SNR is larger than the SNR target, and when the SNR is larger than the SNR target, the RF receiver is operated in the low-power mode.

17. The user equipment of claim 11, wherein the current scenario is one of the service applications of the UE.

18. The user equipment of claim 17, wherein the current scenario is a voice application or a data reception.

19. The user equipment of claim 11, wherein the current scenario is one of the environmental conditions.

20. The user equipment of claim 19, wherein the current scenario is existence of down link (DL) received-signal-strength-indication (RSSI) or existence of co-channel interference (CCI).
